(19) United States
(12) Patent Application Publication
(10) Pub. No.: US 2023/0273500 A1
(43) Pub. Date: Aug. 31, 2023

(54) OPTICAL STRUCTURE

(71) Applicant: InnoLux Corporation, Miao-Li County (TW)

(72) Inventors: Te-Yu LEE, Miao-Li County (TW); Yu-Tsung LIU, Miao-Li County (TW); Cheng-Hsueh HSIEH, Miao-Li County (TW); Wei-Ju LIAO, Miao-Li County (TW)

(21) Appl. No.: 18/153,772

(22) Filed: Jan. 12, 2023

(30) Foreign Application Priority Data
Feb. 25, 2022 (CN) 202210181222.2

(51) Int. Cl. G02F 1/29; G02C 7/08

(52) U.S. Cl. CPC G02F 1/294; G02C 7/083; G02F 2202/16; G02F 2201/50

(57) ABSTRACT

An optical structure is provided. The optical structure includes a first substrate, a second substrate, a sealant, a light-modulating layer and a first conductive layer. The second substrate is disposed opposite to the first substrate. The sealant is disposed between the first substrate and the second substrate. The sealant is disposed around to form a visible area. The light-modulating layer is disposed in the visible region between the first substrate and the second substrate. The first conductive layer has a plurality of strip structures. The plurality of strip structures are disposed in the visible area to form an effective area. The visible area partially overlaps the effective area.

### CROSS REFERENCE TO RELATED APPLICATIONS

This application claims the benefit of China Application No. 202210181222.2, filed Feb. 25, 2022, the entirety of which is incorporated by reference herein.

### BACKGROUND

### Technical Field

The present disclosure is related to an optical structure, and in particular it is related to an optical structure with modulation functions.

### Description of the Related Art

Optical sensing devices are widely used in consumer electronics such as glasses, wearable devices, and smartphones, and have become indispensable necessities in modern society. With the rapid development of these consumer electronics, consumers have high expectations on the quality, functionality, or price of these products.

The lenses used in glasses are among the most common optical structures. Generally, a lens has a fixed focal length, so when the user needs to use lenses with different focal lengths (for example, the user has myopia and presbyopia at the same time, or needs to change the prescription of glasses according to different situations), they usually need to buy additional lenses or glasses.

In view of the aforementioned problems, developing a lens structure with an automatic focus adjustment function is one of the current research topics in the industry.

### SUMMARY

In accordance with some embodiments of the present disclosure, an optical structure is provided. The optical structure includes a first substrate, a second substrate, a sealant, a light-modulating layer and a first conductive layer. The second substrate is disposed opposite to the first substrate. The sealant is disposed between the first substrate and the second substrate. The sealant is disposed around to form a visible area. The light-modulating layer is disposed in the visible region between the first substrate and the second substrate. The first conductive layer has a plurality of strip structures. The plurality of strip structures are disposed in the visible area to form an effective area. In addition, the visible area partially overlaps the effective area.

A detailed description is given in the following embodiments with reference to the accompanying drawings.

### BRIEF DESCRIPTION OF THE DRAWINGS

The disclosure may be more fully understood by reading the subsequent detailed description and examples with references made to the accompanying drawings, wherein:

FIG. 1 is a top-view diagram of an optical structure in accordance with some embodiments of the present disclosure;

FIG. 2 is a top-view diagram of an optical structure in accordance with some other embodiments of the present disclosure;

FIG. 3 is a cross-sectional diagram of an optical structure corresponding to the section line X-X′ of FIG. 1 in accordance with some embodiments of the present disclosure;

FIG. 4 is a cross-sectional diagram of an optical structure corresponding to the section line X-X′ of FIG. 1 in accordance with some other embodiments of the present disclosure;

FIG. 5 is a cross-sectional diagram of an optical structure corresponding to the section line X-X′ of FIG. 1 in accordance with some other embodiments of the present disclosure;

FIG. 6 is a schematic diagram of an optical device having an optical structure in accordance with some embodiments of the present disclosure.

### DETAILED DESCRIPTION

The optical structure according to the present disclosure is described in detail in the following description. It should be understood that in the following detailed description, for purposes of explanation, numerous specific details and embodiments are set forth in order to provide a thorough understanding of the present disclosure. The elements and configurations described in the following detailed description are set forth in order to clearly describe the present disclosure. These embodiments are used merely for the purpose of illustration, and the present disclosure is not limited thereto. In addition, different embodiments may use like and/or corresponding numerals to denote like and/or corresponding elements in order to clearly describe the present disclosure. However, the use of like and/or corresponding numerals of different embodiments does not suggest any correlation between different embodiments.

It should be understood that relative expressions may be used in the embodiments. For example, “lower”, “bottom”, “higher” or “top” are used to describe the position of one element relative to another. It should be appreciated that if a device is flipped upside down, an element that is “lower” will become an element that is “higher”. The present disclosure can be understood by referring to the following detailed description in connection with the accompanying drawings. The drawings are also regarded as part of the description of the present disclosure. It should be understood that the drawings of the present disclosure may be not drawn to scale. In fact, the size of the elements may be arbitrarily enlarged or reduced to clearly represent the features of the present disclosure.

Furthermore, the expression “a first material layer is disposed on or over a second material layer” may indicate that the first material layer is in direct contact with the second material layer, or it may indicate that the first material layer is in indirect contact with the second material layer. In the situation where the first material layer is in indirect contact with the second material layer, there may be one or more intermediate layers between the first material layer and the second material layer. However, the expression “the first material layer is directly disposed on or over the second material layer” means that the first material layer is in direct contact with the second material layer, and there is no intermediate element or layer between the first material layer and the second material layer.

Moreover, it should be understood that the ordinal numbers used in the specification and claims, such as the terms “first”, “second”, etc., are used to modify an element, which itself does not mean and represent that the element (or elements) has any previous ordinal number, and does not mean the order of a certain element and another element, or the order in the manufacturing method. The use of these ordinal numbers is to make an element with a certain name can be clearly distinguished from another element with the same name. Claims and the specification may not use the same terms. For example, the first element in the specification may refer to the second element in the claims.

In accordance with the embodiments of the present disclosure, regarding the terms such as “connected to”, “interconnected with”, etc. referring to bonding and connection, unless specifically defined, these terms mean that two structures are in direct contact or two structures are not in direct contact, and other structures are provided to be disposed between the two structures. The terms for bonding and connecting may also include the case where both structures are movable or both structures are fixed. In addition, the term “electrically connected to” or “electrically coupled to” may include any direct or indirect electrical connection means.

In the following descriptions, terms “about” and “substantially” typically mean +/−10% of the stated value, or typically +/−5% of the stated value, or typically +/−3% of the stated value, or typically +/−2% of the stated value, or typically +/−1% of the stated value or typically +/−0.5% of the stated value. The expression “in a range from the first value to the second value” or “between the first value and the second value” means that the range includes the first value, the second value, and other values in between.

It should be understood that in the following embodiments, without departing from the spirit of the present disclosure, the features in several different embodiments can be replaced, recombined, and mixed to complete another embodiment. The features between the various embodiments can be mixed and matched arbitrarily as long as they do not violate or conflict the spirit of the present disclosure.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In accordance with the embodiments of the present disclosure, an optical structure is provided, which has the function of adjusting the focal length, and can meet the needs of users to use lenses with different focal lengths in response to different situations. Furthermore, in accordance with the embodiments of the present disclosure, various structural designs that can improve the performance or reliability of the optical structure are also provided.

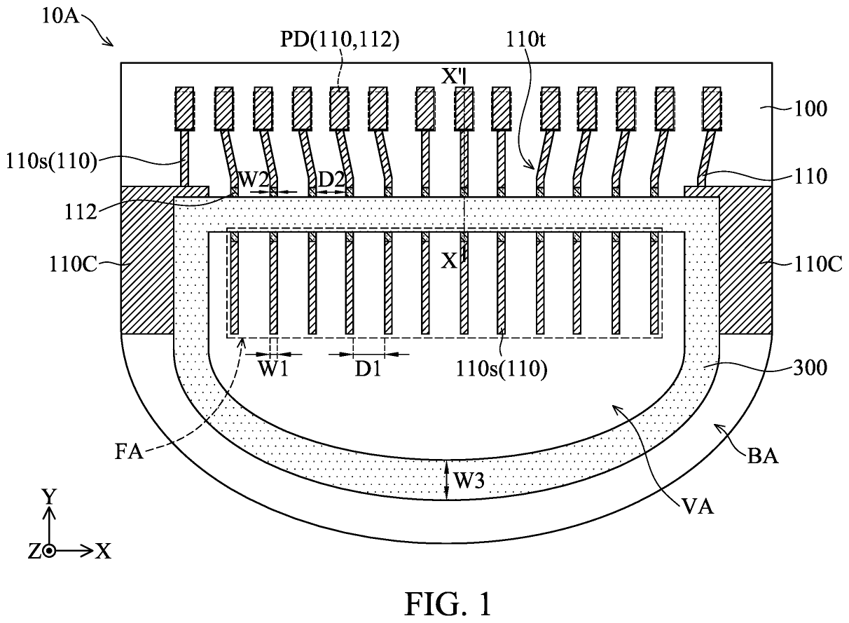

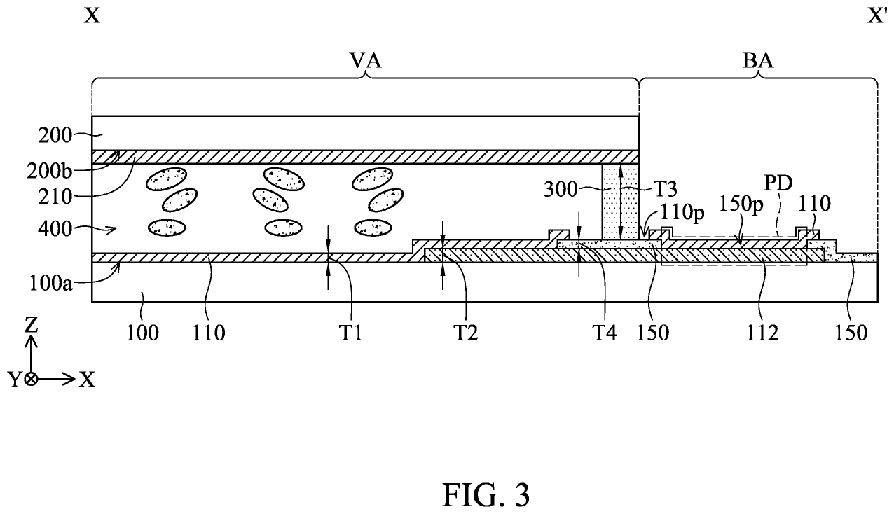

Refer to FIG. 1 and FIG. 3 at the same time. FIG. 1 is a top-view diagram of an optical structure 10A in accordance with some embodiments of the present disclosure. Specifically, FIG. 1 shows the top-view diagram of the first substrate 100 of the optical structure 10A and the elements formed thereon. FIG. 3 is a cross-sectional diagram of the optical structure 10A corresponding to the section line X-X′ of FIG. 1 in accordance with some embodiments of the present disclosure.

It should be understood that, some elements of the optical structure 10A (for example, the protective layer 150, etc.) are omitted in FIG. 1 for clarity, and only some elements are schematically shown. Furthermore, in accordance with some embodiments, additional features may be added to the optical structure 10A described below. In accordance with some other embodiments, some features of the optical structure 10A described below may be replaced or omitted.

As shown in FIG. 1 and FIG. 3, in accordance with some embodiments, the optical structure 10A includes a first substrate 100, a second substrate 200, a sealant 300, a light-modulating layer 400, a first conductive layer 110 and a second conductive layer 210. The second substrate 200 may be disposed opposite to the first substrate 100. The sealant 300 and the light-modulating layer 400 may be disposed between the first substrate 100 and the second substrate 200. The first conductive layer 110 may be disposed on an upper surface 100a of the first substrate 100, and the second conductive layer 210 may be disposed on a lower surface 200b of the second substrate 200.

The first substrate 100 and the second substrate 200 may include a flexible substrate, a rigid substrate or a combination thereof, but they are not limited thereto. In accordance with some embodiments, the materials of the first substrate 100 and the second substrate 200 may include glass, quartz, sapphire, ceramic, polyimide (PI), liquid-crystal polymer (LCP) material, polycarbonate (PC), polyethylene terephthalate (PET), polypropylene (PP), another suitable substrate material or a combination thereof, but they are not limited thereto. The first substrate 100 and the second substrate 200 may be transparent substrates. Furthermore, the material of the first substrate 100 may be the same as or different from that of the second substrate 200.

Moreover, the sealant 300 may be disposed around to form a visible area VA. The sealant 300 may be used to fix and assemble the first substrate 100 and the second substrate 108, and maintain the light-modulating layer 400 in the visible area VA. In accordance with some embodiments, the visible area VA is located in the sealant 300, and a peripheral area BA is disposed adjacent to the visible area VA. Specifically, the sealant 300 may be disposed around to form a closed area, and the closed area is the visible area VA. In accordance with the embodiments of the present disclosure, the sealant 300 can define the visible area VA and the peripheral area BA of the optical structure 10A, the visible area VA corresponds to the area inside the sealant 300, and the peripheral area BA corresponds to the sealant 300 and the area extending outward from the sealant 300 to the outermost edge of the first substrate 100.

Moreover, the sealant 300 may have a width W3 and a thickness T3. In accordance with some embodiments, the width W3 of the sealant 300 may be between 100 μm and 2000 μm (i.e. 100 μm≤width W3≤2000 μm), or between 500 μm and 1500 μm, for example, 600 μm, 700 μm, 800 μm, 900 μm, 1000 μm, 1100 μm, 1200 μm, 1300 μm or 1400 μm. In accordance with some embodiments, the thickness T3 of the sealant 300 may be between 10 μm and 100 μm (i.e. 10 μm≤thickness T3≤100 μm), for example, 20 μm, 30 μm, 40 μm, 50 μm, 60 μm, 70 μm, 80 μm or 90 μm.

Specifically, the aforementioned width W3 refers to the maximum width of the sealant 300 in a direction perpendicular to the extending direction of the sealant 300. The aforementioned thickness T3 refers to the maximum thickness of the sealant 300 in the normal direction of the first substrate 100 (e.g., the Z direction in the drawing).

It should be understood that, in accordance with the embodiments of the present disclosure, an optical microscope (OM), a scanning electron microscope (SEM), a film thickness profiler (α-step), an ellipsometer or another suitable method may be used to measure the spacing or distance between elements, or the width, thickness or height of each element. Specifically, in accordance with some embodiments, a scanning electron microscope may be used to obtain a cross-sectional image including the elements to be measured, and the spacing or distance between elements, or the width, thickness or height of each element in the image can be measured.

The material of the sealant 300 may have an adhesive function. In accordance with some embodiments, the material of the sealant 300 may include a light-curable adhesive material, a heat-curable adhesive material, a light-heat-curable adhesive material, another suitable material, or a combination thereof, but it is not limited thereto. For example, in accordance with some embodiments, the sealant 300 may include, but is not limited to, optical clear adhesive (OCA), optical clear resin (OCR), pressure sensitive adhesive (PSA), another suitable material, or a combination thereof. Furthermore, the sealant 300 may be transparent.

In accordance with some embodiments, the sealant 300 may be formed on the first substrate 100 by a coating process, a spraying process, a printing process, another suitable process, or a combination thereof, but the present disclosure is not limited thereto.

As described above, the light-modulating layer 400 may be disposed in the visible area VA between the first substrate 100 and the second substrate 200. The light-modulating layer 400 may include modulating materials that can be tuned to have different properties (e.g., dielectric coefficient) via application of an electric field or otherwise.

In accordance with some embodiments, the light-modulating layer 400 may include a liquid-crystal material, but it is not limited thereto. The liquid-crystal material may include, for example, nematic liquid crystals, smectic liquid crystals, cholesteric liquid crystals, blue-phase liquid crystals, another suitable liquid-crystal material, or a combination thereof, but it is not limited thereto. In accordance with some embodiments, the light-modulating layer 400 can change the arrangement direction and angle of the liquid-crystal molecules according to different electric fields, thereby adjusting the focal length position of the optical structure 10A.

In accordance with some embodiments, the modulating material can be filled in the sealant 300 to form the light-modulating layer 400 by an absorption method, a one drop filling (ODF) method, another suitable method or a combination thereof, but the present disclosure is not limited thereto.

As shown in FIG. 1, the first conductive layer 110 may have a plurality of strip structures 110s, and the plurality of strip structures 110s may be disposed in the visible area VA to form an effective area FA. Specifically, in accordance with some embodiments, the effective area FA refers to the area formed by the outermost edge of the first conductive layer 110 in the sealant 300 (or the visible area VA). Furthermore, the effective area FA may also represent the area in the visible area VA that can effectively control the light-modulating layer 400, but it is not limited thereto.

In accordance with some embodiments, the optical structure 10A may further include an external driving circuit (not illustrated), the external driving circuit may send out a signal (for example, a driving signal), and the external driving circuit may transmit the signal from the peripheral area BA to the effective area FA through the first conductive layer 110. In accordance with some embodiments, the driving element (not illustrated) for controlling the external driving circuit may include an integrated circuit (IC), a microchip or another suitable driving element, but it is not limited thereto. The structural design of the electrical connection between the first conductive layer 110 and the external driving circuit will be further described below.

As described above, the strip structures 110s of the first conductive layer 110 can form the effective area FA. It should be noted that the visible area VA partially overlaps the effective area FA. Specifically, in the normal direction of the first substrate 100 (e.g., the Z direction in the drawing), the visible area VA partially overlaps the effective area FA. In accordance with some embodiments, a ratio of an overlapping area of the effective area FA and the visible area VA to an area of the visible area VA is between 0.1 and 0.8 (i.e. 0.1≤the overlapping area of the effective area FA and the visible area VA/the area of the visible area VA≤0.8), for example, 0.2, 0.3, 0.4, 0.5, 0.6 or 0.7, but it is not limited thereto. It should be understood that, by controlling the ratio of the overlapping area of the effective area FA and the visible area VA to the area of the visible area VA within the aforementioned range, the strip structures 110s of the first conductive layer 110 can be effectively controlled with relatively few driving elements. In this way, the manufacturing cost or power consumption can be reduced.

Still referring to FIG. 1 and FIG. 3, in accordance with some embodiments, the first conductive layer 110 is further disposed in the peripheral area BA. In other words, a portion of the first conductive layer 110 may be disposed in the visible area VA, and a portion of the first conductive layer 110 may be disposed in the peripheral area BA. Specifically, the first conductive layer 110 may be extended and disposed in the visible area VA and the peripheral area BA, and the sealant 300 may be disposed on the first conductive layer 110. In accordance with some embodiments, the strip structure 110s of the first conductive layer 110 may have a bent portion 110t. In accordance with some embodiments, the plurality of strip structures 110s of the first conductive layer 110 may have different lengths.

Specifically, the length of the strip structure 110s of the first conductive layer 110 refers to the overall length of the first conductive layer 110 (including the pad PD) in the extending direction of the strip structure 110s. Moreover, the length can be measured from one side of the first conductive layer 110 (for example, the left side or the right side in the drawing).

In addition, the strip structure 110s of the first conductive layer 110 may have a width W1 and a thickness T1. In accordance with some embodiments, the width W1 of the strip structure 110s is between 5 μm and 100 μm (i.e. 5 μm≤width W1≤100 μm), for example, 10 μm, 15 μm, 20 μm, 25 μm, 35 μm, 45 μm, 55 μm, 65 μm, 75 μm, 85 μm or 95 μm, but it is not limited to. In accordance with some embodiments, the thickness T1 of the strip structure 110s is between 50 Å and 3000 Å (i.e. 50 Å≤thickness T1≤3000 Å), for example, 100 Å, 150 Å, 200 Å, 250 Å, 500 Å, 750 Å, 1000 Å, 1250 Å, 1500 Å, 1750 Å, 2000 Å, 2250 Å, 2500 Å, or 2750 Å. In addition, adjacent strip structures 110s may be separated by a distance D 1. In accordance with some embodiments, the distance D1 between the adjacent strip structures 110s is between 0.5 μm and 20 μm (i.e. 0.5 μm≤distance D1≤20 μm), for example, 1 μm, 1.5 μm, 2 μm, 2.5 μm, 3 μm, 3.5 μm, 4 μm, 6 μm, 8 μm, 10 μm, 12 μm, 14 μm, 16 μm or 18 μm.

Specifically, the aforementioned width W1 refers to the maximum width of the strip structure 110s in a direction perpendicular to the extending direction of the strip structure 110s (e.g., the X direction in the drawing), and the width W1 is the width of the strip structure 110s in the visible area VA. The aforementioned thickness T1 refers to the maximum thickness of the strip structures 110s in the normal direction of the first substrate 100 (e.g., the Z direction in the drawing). Furthermore, the aforementioned distance D1 refers to the minimum distance between two adjacent strip structures 110s in the visible area VA in a direction perpendicular to the extending direction of the strip structure 110s (e.g., the X direction in the drawing).

In accordance with some embodiments, the material of the first conductive layer 110 may include a transparent conductive material. The transparent conductive material may include transparent conductive oxide (TCO), for example may include indium tin oxide (ITO), antimony zinc oxide (AZO), tin oxide (SnO), zinc oxide (ZnO), indium zinc oxide (IZO), indium gallium zinc oxide (IGZO), indium tin zinc oxide (ITZO), antimony tin oxide (ATO), another suitable transparent conductive material, or a combination thereof, but it is not limited thereto.

In accordance with some embodiments, the first conductive layer 110 may be formed on the first substrate 100 by a chemical vapor deposition process, a physical vapor deposition process, an electroplating process, an electroless plating process, another suitable process, or a combination thereof. For example, the chemical vapor deposition process may include a low-pressure chemical vapor deposition (LPCVD) process, a low-temperature chemical vapor deposition (LTCVD) process, a rapid thermal chemical vapor deposition (RTCVD) process, a plasma enhanced chemical vapor deposition (PECVD) process or an atomic layer deposition (ALD) process, etc., but it is not limited thereto. For example, the physical vapor deposition process may include a sputtering process, an evaporation process, or a pulsed laser deposition, etc., but it is not limited thereto. In accordance with some embodiments, the first conductive layer 110 may be patterned by one or more photolithography processes and/or etching processes. In accordance with some embodiments, the photolithography process may include, but is not limited to, photoresist coating (such as spin coating), soft baking, hard baking, mask alignment, exposure, post-exposure baking, photoresist development, cleaning and drying. The etching process may include a dry etching process or a wet etching process, but it is not limited thereto.

In addition, as shown in FIG. 1, in accordance with some embodiments, the optical structure 10A may further include a common conductive element 110C, the common conductive element 110C may be disposed on the first substrate 100, and the first conductive layer 110 (including a plurality of strips structure) may be electrically connected to the common conductive element 110C. In accordance with some embodiments, the common conductive element 110C may also be disposed on the second substrate 200, and the common conductive element 110C disposed on the first substrate 100 may be electrically connected to the common conductive element 110C disposed on the second substrate 200. In accordance with some embodiments, the common conductive element 110C and the first conductive layer 110 may be the same layer in the optical structure 10A.

Furthermore, the material of the common conductive element 110C may include a conductive material, such as a metal conductive material, a transparent conductive material, another suitable conductive material or a combination thereof, but it is not limited thereto. For example, the metal conductive material may include molybdenum (Mo), copper (Cu), silver (Ag), gold (Au), tin (Sn), aluminum (Al), tungsten (W), chromium (Cr), nickel (Ni), platinum (Pt), titanium (Ti), alloys of the aforementioned metals, another suitable material, or a combination thereof, but it is not limited thereto. The transparent conductive material is similar to that of the first conductive layer 110 as described above, and thus will not be repeated here. Moreover, the material of the common conductive element 110C may be the same as or different from that of the first conductive layer 110.

In accordance with some embodiments, the common conductive element 110C may be formed on the first substrate 100 by a chemical vapor deposition process, a physical vapor deposition process, an electroplating process, an electroless plating process, another suitable process, or a combination thereof. In accordance with some embodiments, the common conductive element 110C may be patterned by one or more photolithography and/or etching processes.

It should be understood that although the optical structure 10A in the drawing has two common conductive elements 110C, the present disclosure is not limited thereto. According to different embodiments, the optical structure may have any suitable number of common conductive elements 110C.

In addition, the second conductive layer 210 may be disposed on the lower surface 200b of the second substrate 200. The second substrate 200 and the second conductive layer 210 may be disposed in the visible area VA, and the second substrate 200 and the second conductive layer 210 may not extend to the peripheral area BA. The sealant 300 may be disposed below the second conductive layer 210. In accordance with some embodiments, the second conductive layer 210 may have a whole surface structure, for example, the second conductive layer 210 may not be patterned, or may substantially fully cover the second substrate 200. In accordance with some embodiments, the second conductive layer 210 may have a strip structure. For example, the second conductive layer 210 may be patterned to form the strip structures 110s similar to the aforementioned first conductive layer 110, and the strip structures 110s of the second conductive layer 210 at least partially overlap the strip structures 110s of the first conductive layer 110.

In accordance with some embodiments, the second conductive layer 210 is electrically connected to the common conductive element 110C (not illustrated) disposed on the second substrate 200. As described above, in accordance with some embodiments, the light-modulating layer 400 can change the arrangement direction and angle of the light-modulating material (for example, liquid-crystal molecules) according to different electric fields. Specifically, the optical properties of the light-modulating layer 400 can be changed by applying different voltages to the first conductive layer 110 and the second conductive layer 210, thereby adjusting the focal length position of the optical structure 10A (e.g., a lens structure), so that the focal length of the optical structure 10A can be easily adjusted according to the usage situation.

Moreover, the material of the second conductive layer 210 may be the same as or similar to the material of the aforementioned first conductive layer 110, and thus it will not be repeated here. In accordance with some embodiments, the second conductive layer 210 may be formed on the second substrate 200 by a chemical vapor deposition process, a physical vapor deposition process, an electroplating process, an electroless plating process, another suitable process, or a combination thereof. In accordance with some embodiments, the second conductive layer 210 may be patterned by one or more photolithography processes and/or etching processes.

Still refer to FIG. 1 and FIG. 3. In accordance with some embodiments, the optical structure 10A may further include a third conductive layer 112. The third conductive layer 112 may be disposed on the first substrate 100 and between the first conductive layer 110 and the first substrate 100, and electrically connected to the first conductive layer 110. In accordance with some embodiments, a portion of the third conductive layer 112 is disposed in the visible area VA, and a portion of the third conductive layer 112 is disposed in the peripheral area BA. In accordance with some embodiments, the third conductive layer 112 partially overlaps the first conductive layer 110 in the normal direction of the first substrate 100 (e.g., the Z direction in the drawing). In accordance with some embodiments, the sealant 300 overlaps the overlapping portion of the third conductive layer 112 and the protective layer 150. Specifically, the third conductive layer 112 and the above first conductive layer 110 in the peripheral area BA can serve as a pad PD. That is, the pad PD may include portions of the third conductive layer 112 and the first conductive layer 110. The pad PD may be further electrically connected to the pad of the chip on film (COF) structure or the flexible printed circuit (FPC) structure of the external driving element, so that the signal of the external driving circuit can be transmitted from the peripheral area BA to the effective area FA through the third conductive layer 112.

Furthermore, the strip structure of the third conductive layer 112 may have a width W2 and a thickness T2. In accordance with some embodiments, the width W2 of the strip structure of the third conductive layer 112 is between 5 μm and 100 μm (i.e. 5 μm≤width W2≤100 μm), for example, 10 μm, 15 μm, 20 μm, 25 μm, 35 μm, 45 μm, 55 μm, 65 μm, 75 μm, 85 μm or 95 μm. In accordance with some embodiments, the thickness T2 of the strip structure of the third conductive layer 112 is between 1000 Å and 3000 Å (i.e. 1000 Å ≤thickness T2≤3000 Å), for example, 1500 Å, 2000 Å or 2500 Å. In addition, adjacent strip structures of the third conductive layer 112 may be separated by a distance D2. In accordance with some embodiments, the distance D2 is between 0.5 μm and 4 μm (i.e. 0.5 μm≤distance D2≤4 μm), for example, 1 μm, 1.5 μm, 2 μm, 2.5 μm, 3 μm or 3.5 μm. Definitions of the width W2, thickness T2 and distance D2 of the third conductive layer 112 are similar to those of the aforementioned first conductive layer 110, and thus will not be repeated here.

In accordance with some embodiments, the material of the third conductive layer 112 may include a metal conductive material, a transparent conductive material, another suitable conductive material or a combination thereof, but it is not limited thereto. The metal conductive material and the transparent conductive material are similar to those of the common conductive element 110C as described above, and thus will not be repeated here. In accordance with some embodiments, the material of the third conductive layer 112 may be a metal conductive material. Furthermore, the material of the third conductive layer 112 disposed in the peripheral area BA may be the same as or different from the material of the third conductive layer 112 disposed in the visible area VA. In accordance with some embodiments, the material of the third conductive layer 112 may be different from that of the first conductive layer 110. For example, the material of the third conductive layer 112 may be a metal conductive material, while the material of the first conductive layer 110 may be a transparent conductive material. Since the resistance of the metal material is relatively low, the electric field difference of the overall conductive materials (first conductive layer 110 and third conductive layer 112) in the visible area VA thereby can be reduced while maintaining the light transmittance of the visible area VA. Therefore, the modulation performance or reliability of the optical structure 10A can be improved.

In accordance with some embodiments, the third conductive layer 112 may be formed on the first substrate 100 by a chemical vapor deposition process, a physical vapor deposition process, an electroplating process, an electroless plating process, another suitable process, or a combination thereof.

As shown in FIG. 3, in accordance with some embodiments, the optical structure 10A may further include a protective layer 150, and the protective layer 150 may be disposed on the first substrate 100. In accordance with some embodiments, the protective layer 150 may be disposed between the first conductive layer 110 and the third conductive layer 112. The protective layer 150 may protect the third conductive layer 112 and reduce the influence of moisture and chemical substances in the environment on the third conductive layer 112. In accordance with some embodiments, the protective layer 150 and the first conductive layer 110 may be disposed on the third conductive layer 112. A portion of the protective layer 150 may be removed by a patterning process to form an opening 150p, and the first conductive layer 110 may cover the opening 150p. The first conductive layer 110 covering the third conductive layer 112 may also reduce the influence of moisture and chemical substances in the environment on the third conductive layer 112. Specifically, the first conductive layer 110 and the third conductive layer 112 corresponding to the opening 150p may serve as a pad PD. Furthermore, the first conductive layer 110 may partially cover the end portion of the protective layer 150 disposed on the third conductive layer 112. The first conductive layer 110 may have an opening 110p to expose a portion of the protective layer 150, and the sealant 300 may be disposed in the opening 110p.

Moreover, the protective layer 150 may have a thickness T4. In accordance with some embodiments, the thickness T4 of the protective layer 150 is between 100 Å and 5000 Å (i.e. 100 Å≤thickness T4≤5000 Å), for example, 500 Å, 1000 Å, 1500 Å, 2000 Å, 2500 Å, 3000 Å, 3500 Å, or 4000 Å.

Specifically, the aforementioned thickness T4 refers to the maximum thickness of the protective layer 150 in the normal direction of the first substrate 100 (e.g., the Z direction in the drawing).

The protective layer 150 may include an organic material, an inorganic material, another suitable material or a combination thereof, but it is not limited thereto. The inorganic material may include, for example, silicon nitride, silicon oxide, silicon oxynitride, aluminum oxide, another suitable material, or a combination thereof, but it is not limited thereto. The organic material may include, for example, epoxy resin, silicone resin, acrylic resin (such as polymethylmethacrylate (PMMA)), polyimide, perfluoroalkoxyalkane (PFA), another suitable material, or a combination thereof, but it is not limited thereto.

In accordance with some embodiments, the protective layer 150 may be formed by a chemical vapor deposition process, a physical vapor deposition process, a coating process, a printing process, another suitable process, or a combination thereof. In accordance with some embodiments, the protective layer 150 may be patterned by one or more photolithography and/or etching processes.

In addition, the protective layer 150 may have a single-layer structure or a multi-layer structure. For example, in some embodiments where the protective layer 150 has a multi-layer structure, the protective layer 150 may include a first layer (not illustrated) and a second layer (not illustrated) disposed on the first layer. The first layer and the second layer may be formed of the same or different materials and may have the same or different thicknesses. In some other embodiments, the protective layer 150 may include a first layer (not illustrated), a second layer (not illustrated) disposed on the first layer, and a third layer (not illustrated) disposed on the second layer. The first layer, the second layer and the third layer may be formed of the same or different materials and may have the same or different thicknesses. For example, the materials of the first layer and the third layer may be inorganic materials, and the material of the second layer may be organic material. In other words, the protective layer 150 may have a stack structure composed of inorganic layer-organic layer-inorganic layer. In accordance with some embodiments, the protective layer 150 having the aforementioned inorganic layer-organic layer-inorganic layer stack structure can further improve waterproof and chemical resistance.

In addition, in accordance with some embodiments, the optical structure 10 may further include an alignment layer (not illustrated), and the alignment layer may be disposed on the upper surface 100a of the first substrate 100 and the lower surface 200b of the second substrate 200. In accordance with some embodiments, the alignment layer may cover the aforementioned conductive layer. The alignment layer can assist in controlling the properties of materials in the light-modulating layer 400 (e.g., dielectric properties or alignment directions, etc.).

In accordance with some embodiments, the material of the alignment layer may include an organic material, an inorganic material, or a combination thereof. For example, the organic material may include polyimide (PI), poly(vinyl cinnamate) (PVCN), polymethylmethacrylate (PMMA), another photoreactive polymer material, or a combination thereof, but it is not limited thereto. For example, the inorganic materials may include silicon dioxide (SiO₂), silicon carbide (SiC), glass, silicon nitride (Si₃N₄), aluminum oxide (Al₂O₃), cerium oxide (CeO₂), another inorganic material with alignment functions, or a combination thereof, but it is not limited thereto.

In accordance with some embodiments, the alignment layer may be formed by a coating process, a chemical deposition process, a printing process, another suitable process, or a combination thereof.

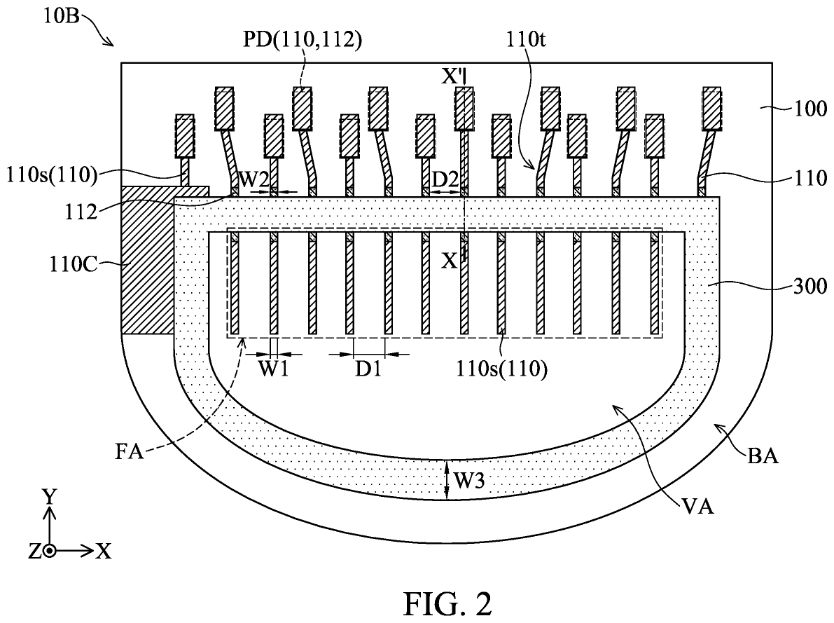

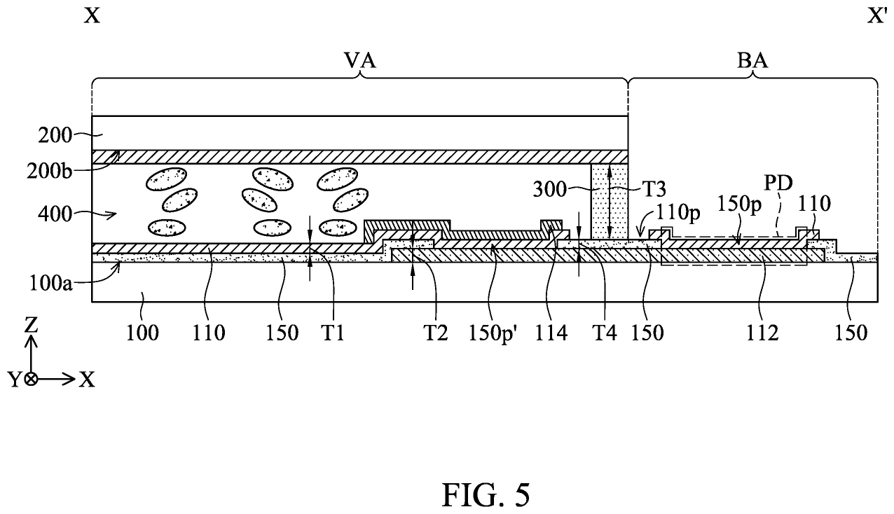

Next, refer to FIG. 2, which is a top-view diagram of an optical structure 10B in accordance with some other embodiments of the present disclosure. Specifically, FIG. 2 shows the first substrate 100 of the optical structure 10B and the elements formed thereon. It should be understood that, some elements of the optical structure 10B (e.g., the protective layer 150, etc.) are omitted in FIG. 5 for clarity, and only some elements are schematically shown. Furthermore, in accordance with some embodiments, additional features may be added to the optical structure 10B described below. In accordance with other embodiments, some features of the optical structure 10B described below may be replaced or omitted.

In addition, it should be understood that the same or similar components or elements in the following paragraph will be denoted by the same or similar reference numbers, and their materials, manufacturing methods and functions are the same or similar to those described above, and thus they will not be repeated in the following context.

The optical structure 10B shown in FIG. 2 is substantially similar to the optical structure 10A shown in FIG. 1. The difference between them includes that, in the optical structure 10B, the arrangement of the third conductive layers 112 may be unaligned. According to different embodiments, the suitable position and size of the pads PD can be adjusted according to the design requirements of the driving circuit. In this embodiment, the plurality of strip structures 110s of the first conductive layer 110 may have different lengths. Furthermore, in this embodiment, the third conductive layers 112 may also have different extension lengths. In this embodiment, only one common conductive element 110C is disposed on the first substrate 100.

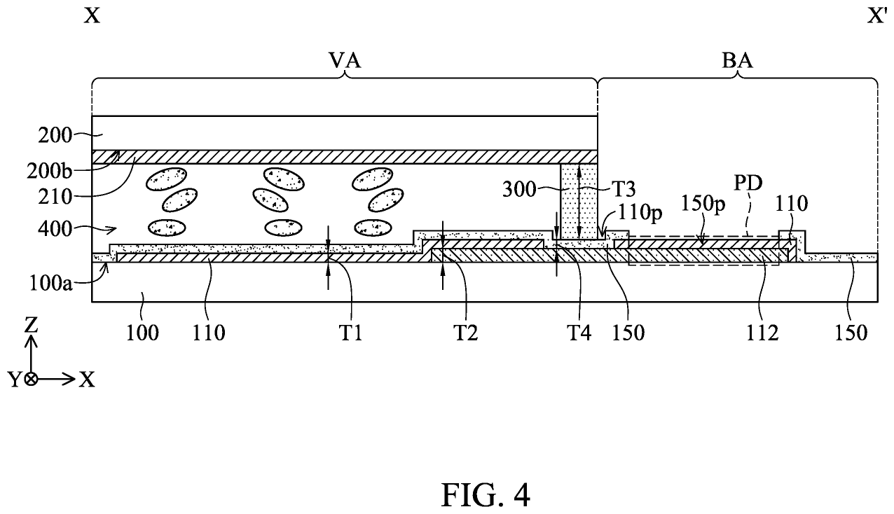

Next, refer to FIG. 4, which is a cross-sectional diagram of an optical structure corresponding to the section line X-X′ of FIG. 1 in accordance with some other embodiments of the present disclosure.

As shown in FIG. 4, in this embodiment, the protective layer 150 is also disposed in the visible area VA, and the protective layer 150 is disposed on the first conductive layer 110 and the third conductive layer 112. Specifically, the protective layer 150 may extend from the visible area VA to the peripheral area BA, and cover the first conductive layer 110 and the third conductive layer 112. The protective layer 150 may be disposed between the third conductive layer 112 and the sealant 300. Moreover, a portion of the protective layer 150 may be removed by a patterning process to form an opening 150p, and the opening 150p may expose a portion of the first conductive layer 110. The first conductive layer 110 and the third conductive layer 112 corresponding to the opening 150p may serve as a pad PD.

In this embodiment, since there is no need to perform a patterning process in the visible area VA to remove the protective layer 150, the risk of remaining protective layer 150 or overetching of the opening 150p can be reduced.

Next, refer to FIG. 5, which is a cross-sectional diagram of an optical structure corresponding to the section line X-X′ of FIG. 1 in accordance with some other embodiments of the present disclosure.

As shown in FIG. 5, in this embodiment, the optical structure further includes a fourth conductive layer 114. The fourth conductive layer 114 may be disposed on the first conductive layer 110, and the fourth conductive layer 114 may be electrically connected to the first conductive layer 110 and the third conductive layer 112. Specifically, in this embodiment, the protective layer 150 is also disposed in the visible area VA, and the protective layer 150 is disposed between the first conductive layer 110 and the third conductive layer 112. The protective layer 150 may extend from the visible area VA to the peripheral area BA, and cover the third conductive layer 112. Moreover, a portion of the protective layer 150 may be removed by a patterning process to form an opening 150p′ and an opening 150p, and the opening 150p′ may expose a portion of the third conductive layer 112. The first conductive layer 110 and the fourth conductive layer 114 may be disposed on the opening 150p′. The fourth conductive layer 114 may be disposed on the third conductive layer 112 and the first conductive layer 110.

In this embodiment, since the fourth conductive layer 114 is further disposed on the first conductive layer 110, the risk of disconnection or high impedance of the first conductive layer 110 at the opening 150 can be reduced, especially when the thickness T1 of the conductive layer 110 of the first conductive layer 110 is much smaller than the thickness T4 of the protective layer 150.

In accordance with some embodiments, the material of the fourth conductive layer 114 may include a metallic conductive material, a transparent conductive material, another suitable conductive material or a combination thereof, but it is not limited thereto. The metal conductive material and the transparent conductive material are similar to those of the common conductive element 110C as described above, and thus will not be repeated here.

In accordance with some embodiments, the fourth conductive layer 114 may be formed on the first conductive layer 110 by a chemical vapor deposition process, a physical vapor deposition process, an electroplating process, an electroless plating process, another suitable process, or a combination thereof.

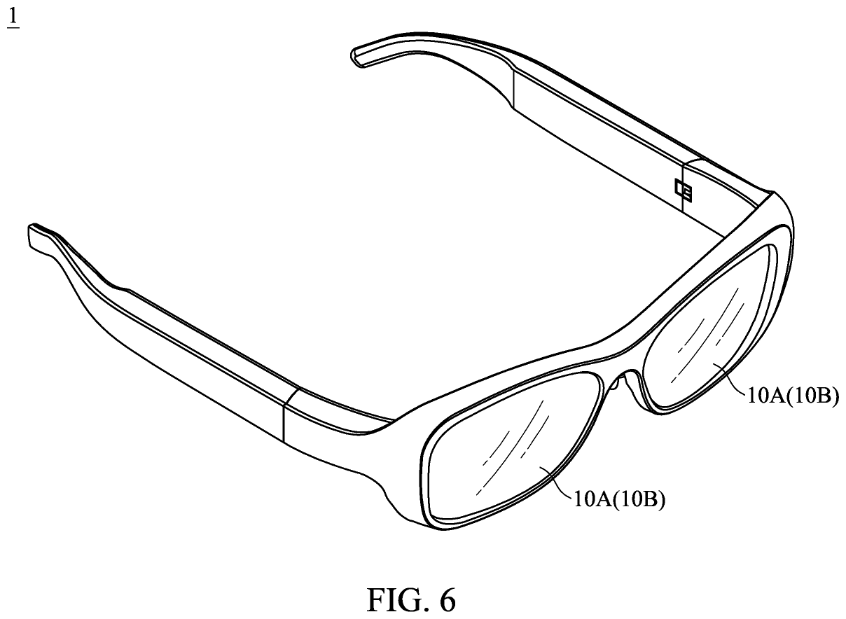

Refer to FIG. 6, which is a schematic diagram of an optical device 1 having the aforementioned optical structure 10A or optical structure 10B in accordance with some embodiments of the present disclosure.

In accordance with some embodiments, the optical device 1 includes glasses, and the optical structure 10A or the optical structure 10B are a lens structure of glasses, but the present disclosure is not limited thereto. As described above, the optical structure 10A or the optical structure 10B has the function of adjusting the focal length, which can meet the needs of users to use lenses with different focal lengths in response to different situations. For example, when a user with presbyopia needs to look at close-up objects, a voltage can be applied to the glasses lens to change the alignment and angle of the light-modulating material (such as liquid-crystal molecules), thereby making the focal length of the glasses lens closer to the user, so that the user can see objects clearly through the glasses lens; when the user with presbyopia needs to see a distant view, another voltage can be applied to the glasses lens to change the arrangement and angle of the light-modulating material (such as liquid-crystal molecules), thereby making the focal length of the glasses lens far away from the user, so that the user can clearly see the distant view through the glasses lens.

Although some embodiments of the present disclosure and their advantages have been described in detail, it should be understood that various changes, substitutions and alterations can be made herein without departing from the spirit and scope of the disclosure as defined by the appended claims. The features of the various embodiments can be used in any combination as long as they do not depart from the spirit and scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Thus, the appended claims are intended to include within their scope such processes, machines, manufacture, compositions of matter, means, methods or steps. Moreover, each claim constitutes an individual embodiment, and the claimed scope of the present disclosure includes the combinations of the claims and embodiments. The scope of protection of present disclosure is subject to the definition of the scope of the appended claims. Any embodiment or claim of the present disclosure does not need to meet all the purposes, advantages, and features disclosed in the present disclosure.

What is claimed is:

1. An optical structure, comprising:
a first substrate;
a second substrate disposed opposite to the first substrate;
a sealant disposed between the first substrate and the second substrate, and the sealant is disposed around to form a visible area;
a light-modulating layer disposed in the visible region between the first substrate and the second substrate; and
a first conductive layer having a plurality of strip structures disposed in the visible area to form an effective area;
wherein the visible area partially overlaps the effective area.

2. The optical structure as claimed in claim 1, wherein a ratio of an overlapping area of the effective area and the visible area to an area of the visible area is between 0.1 and 0.8.

3. The optical structure as claimed in claim 1, further comprising a second conductive layer disposed on a lower surface of the second substrate.

4. The optical structure as claimed in claim 3, wherein the second conductive layer has a whole surface structure or a strip structure.

5. The optical structure as claimed in claim 1, wherein the visible area is located in the sealant, and a peripheral area is disposed adjacent to the visible area.

6. The optical structure as claimed in claim 5, wherein the first conductive layer is further disposed in the peripheral area.

7. The optical structure as claimed in claim 5, further comprising an external driving circuit, wherein the external driving circuit sends out a signal, and the external driving circuit transmits the signal from the peripheral area to the effective area through the first conductive layer.

8. The optical structure as claimed in claim 1, wherein at least one of the plurality of strip structures has a bent portion.

9. The optical structure as claimed in claim 1, wherein at least two of the plurality of strip structures have different lengths.

10. The optical structure as claimed in claim 1, further comprising a third conductive layer, wherein the third conductive layer is disposed between the first conductive layer and the first substrate, and the third conductive layer is electrically connected to the first conductive layer.

11. The optical structure as claimed in claim 10, further comprising a protective layer disposed on the first substrate.

12. The optical structure as claimed in claim 11, wherein the protective layer is disposed on the first conductive layer and the third conductive layer.

13. The optical structure as claimed in claim 11, wherein the protective layer is disposed between the first conductive layer and the third conductive layer.

14. The optical structure as claimed in claim 13, further comprising a fourth conductive layer, wherein the fourth conductive layer is disposed on the first conductive layer, and the fourth conductive layer is electrically connected to at least one of the first conductive layer and the third conductive layer.

15. The optical structure as claimed in claim 10, wherein a material of the third conductive layer is a metal conductive material.

16. The optical structure as claimed in claim 11, wherein the protective layer comprises a first layer and a second layer disposed on the first layer.

17. The optical structure as claimed in claim 16, wherein the protective layer further comprises a third layer disposed on the second layer.

18. The optical structure as claimed in claim 17, wherein a material of the first layer and the third layer is an inorganic material, and a material of the second layer is an organic material.

19. The optical structure as claimed in claim 10, wherein the third conductive layer partially overlaps the first conductive layer.

20. The optical structure as claimed in claim 14, wherein the fourth conductive layer partially overlaps the protective layer.
